(19) United States
(12) Patent Application Publication
(10) Pub. No.: US 2010/0186593 A1
(43) Pub. Date: Jul. 29, 2010

(54) NON-DISCHARGING TYPE AIR PURIFICATION EQUIPMENT FOR THE INDUSTRY

(76) Inventor: Bu Yeol Kim, Gyeonggi-Do (KR)

Correspondence Address: HYUN JONG PARK;Park & Associates IP Law LLC, 265 Bic Drive, Suite 106, Milford, CT, 06461, US

(21) Appl. No.: 12/161,774

(22) PCT Filed: Sep. 22, 2006
(86) PCT No.: PCT/KR2006/003768

§ 371 Date: Jul. 22, 2008

(30) Foreign Application Priority Data
Jan. 23, 2006 (KR) 10-2006-0006932

(51) Int. Cl. B03C 3/011; B03C 3/38

(52) U.S. Cl. 96/19; 96/65; 96/57

(57) ABSTRACT

A non-discharge type air purification apparatus for industry is disclosed, which is able to effectively remove a smell substance and pollutant contained in an exhaust gas by supplying an enough amount of anion with the help of a multi-step anion generation unit without a high voltage discharge. The apparatus comprises a main body part, a heating part which is connected with the main body part and the pipeline and heats a fluid for supplying a heating fluid as a supply medium of the heat for generating anion in the interior of the main body part, a circulation pump which is installed at a pipeline between the main body part and the heating part and circulates the fluid heated by the heating part in the interior of the main body part, an air discharge part which is mechanically connected with the gas outlet side of the main body part and forcibly discharges the air purified in the main body part to the outside of the main body part, and a control part which is installed near the main body part and is electrically connected with the circulation pump and air discharge part for thereby controlling the operations of the same.

### TECHNICAL FIELD

The present invention relates to a non-discharge type air purification apparatus for industry, and in particular to a non-discharge type air purification apparatus for industry which is able to effectively purify a band smell substance and a polluted substance contained in an exhaust air by supplying an enough amount of anion using a multi-step anion generator, not depending on a high voltage discharge.

### BACKGROUND ART

Generally, since an air circulation is not good in an indoor space such as an office, a school, a hotel, a restaurant, a factory, etc., a pollution substance such as an exhaust gas of a vehicle, a tobacco smoke, dusts, etc. and a mite, a fungi, a virus and pollen and various polymer chemical substances contained in thermal insulating material may cause various diseases such as a respiratory disease or skin disease.

So, as a method for purifying indoor air, many researches are conducted. As an example, micro dusts or pollution material such as bacteria are conducted to minus electrons with the help of an electric force. According to an electron type anion generation and air purification apparatus, the thus substances are forced to attach on a dust collection filter of a dust collection electrode which generates a positive power. The polluted substances are purified by ozone.

FIG. 1 is a view illustrating a construction of a conventional anion generation air purification apparatus.

As shown therein, a conventional anion generation air purification apparatus (registration utility model gazette, laid-open number 20-0158927) comprises a body 10 which has an operation panel 12 at one side of the same and a negative electrode needle 11 for generating a negative voltage, a cylindrical dust collection electrode engaging box 20 which is engaged at the body 10 and a cylindrical dust collection electrode 21 for generating a positive voltage, and an outer case 30 which surrounds the dust collection electrode engaging box 20 and has a plurality of air inlet holes at an outer surface of the same. In FIG. 1, reference numeral 11a is a needle piece, 21a is a through hole, 23 is a dust collection electrode engaging part, 23a is a through hole, 40 is a fan, 41 is a motor, 50 is an upper cap, and 51 is an air discharge hole.

According to the conventional anion generation air purification apparatus, the operation panel 12 installed at one side of the body 10 is operated, and the power is supplied. As the motor 41 installed in the interior of the dust collection electrode engaging box 20 is driven, the fan 40 starts rotating, and the polluted air in the indoor inputted via the air inlet hole formed at the outer case 30 is forced to flow into the interior. At this time, the negative electrode needle 11 is conducted with the minus current, and the dust collection electrode 21 is conducted with the plus current, so that the dusts are moved to the dust collection electrode 21, and various pollutants such as dusts, etc. are collected. The filtered air by the dust collection filter 22 flows into the interior of the dust collection electrode engaging box 20 via the through hole 21a formed at the dust collection electrode 21 and the through hole 23a formed at an intermediate portion of the dust collection electrode engaging part 23 with the help of the fan 40 installed in the interior of the dust collection engaging box 20. The inputted purified air is discharged into the indoor via the air discharge hole 51 formed at the upper cap 50 and is spread.

### DISCLOSURE OF INVENTION

### Technical Problem

It is another object of the present invention to provide a non-discharge type air purification apparatus for industry which is able to effectively remove a smell substance and pollutant contained in an exhaust gas by supplying an enough amount of anion with the help of a multi-step anion generation unit without a high voltage discharge.

### Advantageous Effects

A non-discharge type air purification apparatus for industry is disclosed, which is able to effectively remove a smell substance and pollutant contained in an exhaust gas by supplying an enough amount of anion with the help of a multi-step anion generation unit without a high voltage discharge.

### BRIEF DESCRIPTION OF THE DRAWINGS

The present invention will become better understood with reference to the accompanying drawings which are given only by way of illustration and thus are not limitative of the present invention, wherein

FIG. 1 is a view illustrating a construction of a conventional anion generation air purification apparatus;

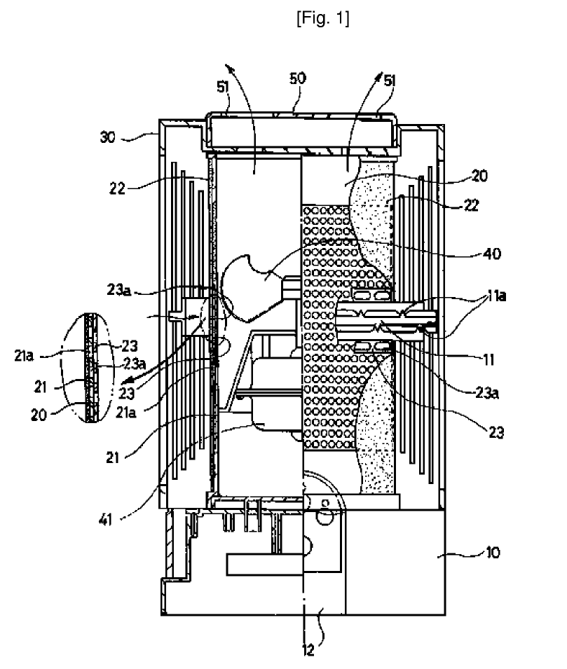

FIG. 2 is a view illustrating a construction of a non-discharge type air purification apparatus for industry according to a first embodiment of the present invention;

FIG. 3 is a view illustrating a construction of a non-discharge type air purification apparatus for industry according to a second embodiment of the present invention; and

FIG. 4 is a view illustrating a construction of a non-discharge type air purification apparatus for industry according to a fourth embodiment of the present invention.

### BEST MODE FOR CARRYING OUT THE INVENTION

To achieve the above objects, there is provided a non-discharge type air purification apparatus for industry which comprises a main body part which has a rectangular cubic body except for an inlet and outlet part of air, with the body being horizontally installed with respect to the ground, for thereby purifying based on a filtering and multiple step anion contact reactions by receiving a bad smell and polluted air into the body; a heating part which is connected with the main body part and the pipeline and heats a fluid for supplying a heating fluid as a supply medium of the heat for generating anion in the interior of the main body part; a circulation pump which is installed at a pipeline between the main body part and the heating part and circulates the fluid heated by the heating part in the interior of the main body part; an air discharge part which is mechanically connected with the gas outlet side of the main body part and forcibly discharges the air purified in the main body part to the outside of the main body part; and a control part which is installed near the main body part and is electrically connected with the circulation pump and air discharge part for thereby controlling the operations of the same.

The preferred embodiment of the present invention will be described with reference to the accompanying drawings.

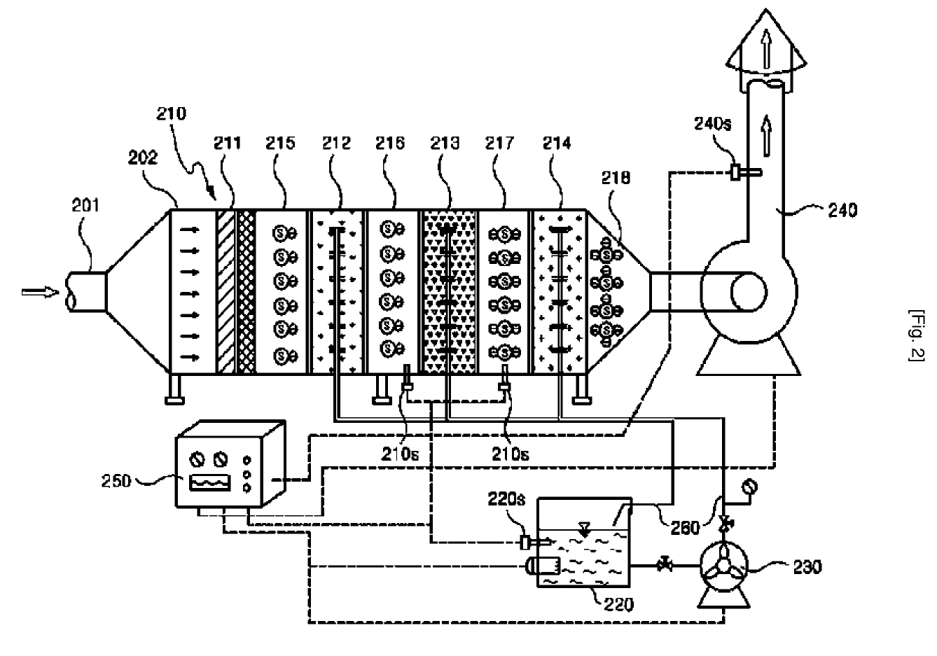

FIG. 2 is a view illustrating a construction of a non-discharge type air purification apparatus for industry according to a first embodiment of the present invention.

As shown therein, the non-discharge type air purification apparatus for industry comprises a main body part 210, a heating part 220, a circulation pump 230, an air discharge part 240, and a control part 250.

The main body part 210 is formed of a rectangular cubic body except for the construction of air inlet and outlet parts. The body is installed horizontally with respect to the ground and receives a bad smell and pollutant which will be purified and purifies the same based on a filtering and an anion contact reaction of multiple steps. The main body part 210 comprises a filter part 211 which first filters a bad smell and pollutant inputted into the body via the inlet part 201 and is formed of a double filtering structure for filtering a relatively larger particle (for example, above 0.5 um) and foreign substance (particular, adhesive dusts), a first anion generation part 212 which is distanced from the filter part 211 and first generates anions based on a first anion contact reaction of the air from which the dust and foreign substances are removed via the filter part 211, a second anion generation part 213 which is installed at a distance from the first anion generation part 212 and generates anion for a second anion contact reaction of the air which had the first anion contact reaction via the first anion generation unit 212, and a third anion generation unit 214 which is distanced from the second anion generation unit 213 and generates anion for a third anion contact reaction of the air which had the second anion contact reaction via the second anion generation part 213. The above elements are sequentially installed.

The inorganic materials for generating the anions in the first through third generation units 212, 213 and 214 are formed of rock salt, rock crystal (purple), natural ore, elvan, feldspar, silicate, yellow earth, mica (black mica, sericite, ceramic (Tourmaline), amber stone, germanium, natural germ, coral stone, Kiyoseki, zeolite, ilite, carbon (charcoal), etc.

Here, the representative bad smell substances which will be inputted into the interior of the main body part 210 and will be removed during the ionization are NH3, CH3SH, H2S, (CH3)2S, CH3SSCH3, (CH3)2S, CH3SSCH3, (CH3)3N, CH3CHO, CH3CH2CHO, CH3(CH2)2CHO, (CH3)2CHCHO, CH3(CH2)3CHO, (CH3)2CHCH2OH, CH3CO2C2H5, CH3COCH2CH(CH3)2, C6H5CH3, C6H5CH═CH2, C6H4(CH3)2, CH3CH2COOH, CH3(CH2)2COOH, CH3(Che)3COOH, (CH3)2CHCH2COOH, and (CH3)2CHCH2CH8.

A temperature sensor 210s is installed at the first anion contact reaction chamber 216 between the first and second anion generation parts 212 and 213 and at the second anion contact reaction chamber 217 between the first and second anion generation. The above temperature sensor 210s is electrically connected with the control part 250.

The heating part 220 is connected with the main body part 210 and the pipeline 260 and heats fluid for supplying a heating liquid as a heat supply medium for generating the anion in the interior of the main body part 210. Since the generation amount of the anion increases in proportion to the heating temperature of the inorganic material, it is needed to heat the surface temperature of the inorganic material to 50˜60 C or above 100 C for increasing the removal efficiency of bad smell. So, an electric heater (air cooling type) or a heating plate is installed at a center, entrance or outlet of the charging part of the inorganic material. The interior of the heating plate is circulated using steam, hot water or hot oil using a circulation pump for thereby increasing the surface temperature of the inorganic material.

As a heating source of the heating part 220, electricity or LPG may be used. In addition, a temperature sensor 220s is installed in the heating tank of the heating part 220 so as to detect the temperature of heating fluid. The temperature sensor 220s is electrically connected with the control part 250. As shown in the drawings, the first, second and third anion generation parts 212, 213 and 214 may have a plurality of divide pipes so that the heat of the heated circulated fluid is uniformly spread in the anion generation part.

The circulation pipe 230 is installed on the pipeline 260 between the main body part 210 and the heating part 220 and allows the fluid heated by the heating part 220 to circulate into the interior of the main body part 210.

The air discharge part 240 is mechanically connected with an air outlet of the main body part 210 and allows the air purified by the main body part 210 to flow to the outside. The air discharge part 240 may be formed of a common blower. A gas concentration sensor 240s is installed at the air discharge pipe (or air discharge duct) of the air discharge part 240 for detecting the concentration of the air (gas). The gas concentration sensor 240s is electrically connected with the control part 250.

The control part 250 is installed near the main body part 210 and is electrically connected with the heating part 220, the circulation pump 230, and the air discharge part 240 and controls the operations of the same. The detection signals are received from the temperature sensor 210s installed at the first and second anion contact reaction chambers 216 and 217 of the main body part 210, the temperature sensor 220s installed at the heating part 220 and the gas concentration sensor 240s installed at the air discharge part 240, and the data corresponding to the same are displayed or a certain signal flashes. So, it is possible to keep the most efficient control and maintenance in the air purification. In particular, the control part 250 transmits a control signal, which controls a heating level of the heating source of the heating part 220, based on a detection signal (concentration of exhaust gas) from the gas concentration sensor 240s and allows the occurrence degree of the heat to decrease or increase, so that the amount of heat energy supplied to the anion generation parts 212, 213 and 214 is controlled. The software programs needed to the controls are made by a designer and are stored in the memory of the control part. As shown in FIG. 2, the reference numeral 202 is a first chamber in which when the bad smell and polluted gas inputted via the inlet part 201 gathers before they pass through the above elements. In the above chamber, the flowing speed of bad smell gas flowing at about 15˜18 m/sec in the duct of the entrance part flows into a rectangular conical shape interior decreases at below 0.3˜1 m/sec. 215 is a second chamber in which air, from which dusts and foreign substances are removed by the filter part 211, gathers, and 218 is a third anion contact reaction chamber in which the air, which completed a second anion contact reaction, performs an anion contact reaction in a third step by the anion generated by the third anion generation part 214.

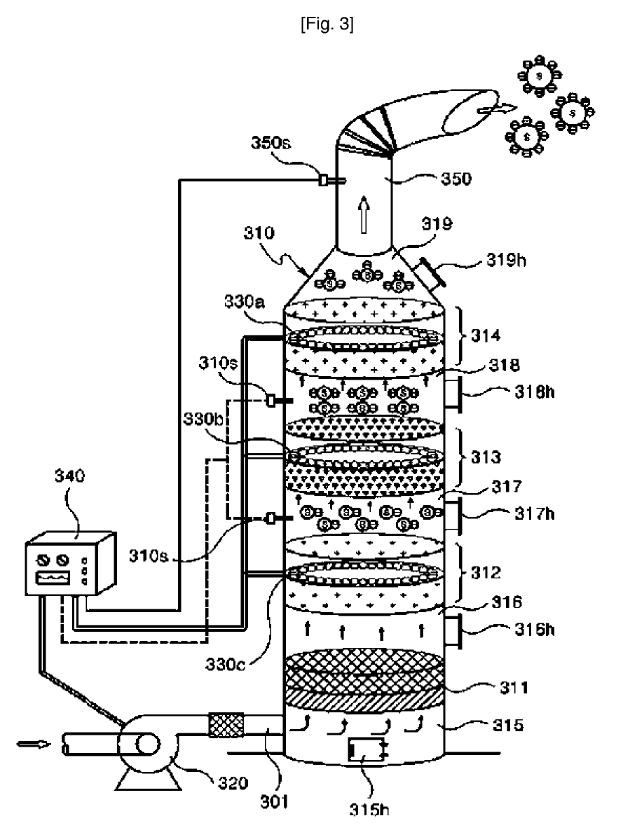

FIG. 3 is a view illustrating a construction of a non-discharge air purification apparatus for industry according to a second embodiment of the present invention.

As shown therein, the non-discharge type air purification apparatus for industry according to the second embodiment of the present invention is very similar with the first embodiment except for the constriction in which the main body part is horizontally installed in the first embodiment, but in the second embodiment, the main body part is vertically installed.

The non-discharge type air purification apparatus for industry according to a second embodiment of the present invention comprises a main body part 310, a gas transmission part 320, heating parts 330a through 330c, and a control part 340.

The main body part 310 has a cylindrical body with the body being vertically installed with respect to the ground, so that bad smell and polluted gas, which will be purified, are purified by the filtering and an anion contact reaction of a multi-step. The main body part 310 comprises a filter part 311 which first filters bad smell and polluted gas inputted into the body like the first embodiment and is formed of a double filter structure for filtering relatively large size particles, a first anion generation part 312 which is distanced from the filter part 311 and generates an anion for a first anion contact reaction of the air from which the dust and foreign substances are moved by the filter part 311, a second anion generation part 313 which is distanced from the first anion generation part 312 and generates an anion for a second anion contact reaction of the air which completed the first anion contact reaction, a third anion generation part 314 which is distanced from the second anion generation part 313 and generates an anion for a third anion contact reaction of the air which had a second anion contact reaction via the second anion generation part 313. The above elements are sequentially installed. Here, the inorganic materials for generating anion in the first through third anion generation parts 312, 313 and 314 are made of rock salt, rock crystal (purple), natural ore, elvan, feldspar, silicate, yellow earth, mica (black mica, sericite, ceramic (Tourmaline), amber stone, germanium, natural germ, coral stone, Kiyoseki, zeolite, ilite, carbon (charcoal), etc.

A temperature sensor 310s is installed at the first anion contact reaction chamber 317 between the first and second anion generation parts 312 and 313 and at the second anion contact reaction chamber 318 between the first and second anion generation. The above temperature sensor 310s is electrically connected with the control part 350.

More preferably, there are provided a first chamber 315 in which inputted bad smell and pollutant gather before passing through the filter part 311, a second chamber 316 in which the air, from which dust and foreign substances are removed by the filter part 311, stays, and manholes 315h through 319h formed in the first through third anion contact reaction chambers 317, 318 and 319 for checking and cleaning each chamber.

A gas concentration sensor 350s is installed at the air discharge pipe (or air discharge duct) for sensing the concentration of the air (gas), with the purified air being discharged to the outside via the third anion contact reaction chamber 319. The gas concentration sensor 350s is electrically connected with the control part 340. The gas transmission part 320 is mechanically connected with the inlet part 301 into which the exhaust gas of the main body part 310 is inputted and allows the bad smell and polluted gas to flow into the interior of the main body part 310. The gas transmission part 320 is formed of a conventional blower.

The heating parts 330a through 330c are installed at the anion generation part of the interior of the main body part 310 and receive external electric energies and generate heat for generating anion in the interior of the main body part 310. The heating parts 330a through 330c are installed at the first through third anion generation parts 312, 313 and 314 of the interior of the main body part 310 and receive electric power via the control part 340 and generate heat for thereby supplying the heat for generating anions. Here, the heating parts 330a through 330c may be formed of common electric heaters. The control part 340 is installed near the main body part 310 and is electrically connected with the gas transmission part 320 and the heating parts 330a through 330c for thereby controlling the same and receives a detection signal from the temperature sensor 310s installed at the first and second anion contact reaction chambers 317 and 318 of the main body part 310 and a gas concentration sensor 350s installed at the air discharge pipe 370 and displays a data corresponding thereto or outputs a flashing signal. Namely, a certain control corresponding to the maintenance and increase of the optimum efficiency. The control part 340 transmits a control signal for controlling the heating degree to the heating sources of the heating parts 330a through 330c for thereby increasing or decreasing the generation amount of heat, so that it is possible to control the amount of heat energy supplied to the anion generation parts 312, 313 and 314. The software programs are previously made by a designer of the apparatus and are stored in the memory of the control part 340.

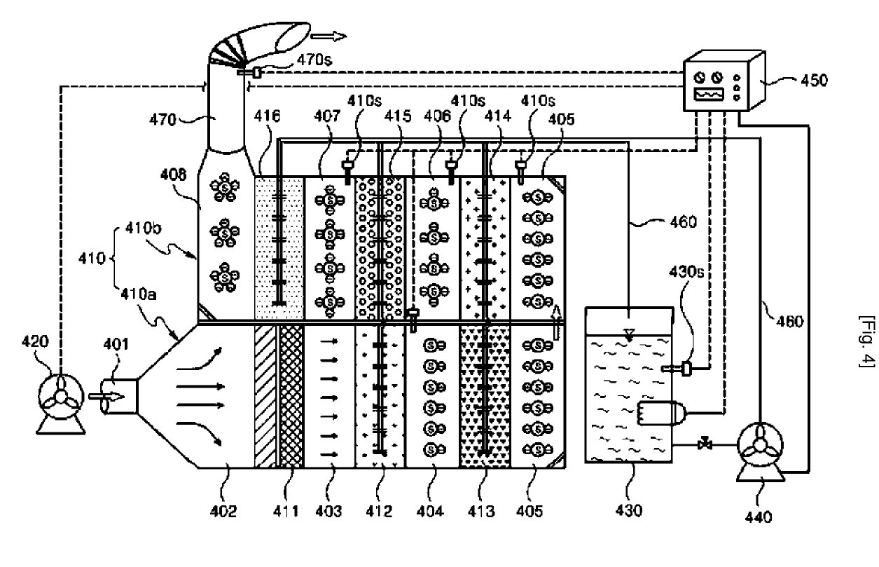

FIG. 4 is a view illustrating a construction of the non-discharge type air purification apparatus for industry according to a third embodiment of the present invention.

As shown in FIG. 4, the non-discharge type air purification apparatus for industry according to the third embodiment of the present invention is implemented based on the construction of the first embodiment except that the main body part is formed in a stacking structure, and the anion generation part and the anion contact reaction chamber are more than that of the first embodiment. The non-discharge type air purification apparatus for industry according to the third embodiment of the present invention comprises a main body part 410, an air transmission part 420, a heating part 430, a circulation pump 440, and a control part 450. According to the main body part 410, two rectangular cubic bodies 410a and 410b are stacked horizontally with respect to the ground and receive the bad smell and polluted air, which will be purified, and purify the same based on the filtering and multi-step anion contact reaction. The main body part 410 comprises a double filter part 411 which filters the bad smell and polluted air (for example, hydrogen sulfide, amines, aldehyde, toluene, Xylene, etc.) inputted via the gas entrance part 401 and filters relatively large size particles, a first anion generation part 412 which is distanced from the filter part 411 and generates an anion for the first anion contact reaction of the air having no dusts and foreign substances via the filter 411, a second anion generation part 413 which is distanced from the first anion generation part 412 for generating an anion for the second anion contact reaction of the air which had the first anion contact reaction via the first anion generation part 412, a third anion generation part 414 which is distanced from the second anion generation part 413 and generates an anion for the third anion contact reaction of the air which had the second anion contact reaction via the second anion generation part 413, a fourth anion generation part 415 which is distanced from the third anion generation part 414 and generates an anion for the fourth anion contact reaction of the air which had the third anion contact reaction via the third anion generation part 414, and a fifth anion generation part 416 which generates an anion for the fifth anion contact reaction of the air which had the fourth anion contact reaction via the fourth anion generation part 415. The inorganic materials used for generating the anion in the first through fifth anion generation parts 412 through 416 may be formed of rock salt, rock crystal (purple), natural ore, elvan, feldspar, silicate, yellow earth, mica (black mica, sericite, ceramic (Tourmaline), amber stone, germanium, natural germ, coral stone, Kiyoseki, zeolite, ilite, carbon (charcoal), etc.

The temperature sensor 410s is respectively installed at a first anion contact reaction chamber 404 between the first anion generation part 412 and the second anion generation part 413, and a second anion contact reaction chamber 405 between the second anion generation part 413 and the third anion generation part 414, and a third anion contact reaction chamber 406 between the third anion generation part 414 and the fourth anion generation part 415, and a fourth anion contact reaction chamber 407 between the fourth anion generation part 415 and the fifth anion generation part 417 for thereby detecting the temperature of the interior of the reaction chamber.

The temperature sensor 410s is electrically connected with the control part 450. An air discharge pipe (or air duct) 470 is formed at the final outlet side of the main body part 410 for discharging purified air. A gas concentration sensor 407s is installed at the air discharge pipe 470 for detecting the concentration of the air (gas). The gas concentration sensor 470s is electrically connected with the control part 450. The air transmission part 420 is mechanically connected with the air inlet part 401 of the main body part 410 and allows the bad smell and polluted air to forcibly flow into the interior of the main body 410. The air transmission part 420 may be formed of the blower. The air transmission part 420 is electrically connected with the control part 450. The heating part 430 is connected with the main body part 410 and the pipeline 460 and heats the fluid for supplying the heating fluid as a supply medium of the heat for generating anions in the interior of the main body part 410. The heating source of the heating part 430 may be formed of the electricity or LPG. In addition, the temperature sensor 430s is installed at the heating tank of the heating part 430 for detecting the temperature of the heating fluid. The temperature sensor 430s is electrically connected with the control part 450. The pipeline 460 is formed of multiple divide pipes so that the heat of the circulation fluid can be uniformly spread over the anion generation parts. The circulation pump 440 is installed on the pipeline 460 connecting the main body part 410 and the heating part 430 and allows the heated fluid by the heating part 430 to circulate in the interior of the main body part 410. The control part 450 is installed near the main body part 410 and is electrically connected with the air transmission part 420, the heating part 430 and the circulation pump 440 and controls the same and displays a certain data in accordance with a detection signal from the temperature sensor 410s installed at the second and fourth anion contact reaction chambers 405, 406 and 407 of the main body part 410 and the gas concentration sensor 470s installed at the air discharge pipe 460 or a certain signal may flash, so that it is possible to control for the optimum maintenance and efficiency increase. In particular, the control part 450 transmits a control signal for controlling the heating degree to the heating source of the heating part 430 based on the detection signal of the gas concentration sensor 470s for thereby increasing or decreasing the generation amount of the heat, so that it is possible to control the heat energy supplied to the anion generation parts 412 through 416. The software programs related to the above control are previously made by a designer of the apparatus and are stored in the memory of the apparatus. As shown in FIG. 4, reference numeral 420 is a first chamber in which the bad smell and polluted air inputted via the inlet part 401 gathers before passing through the filter part 411, and 403 is a second chamber in which the air having no dusts and foreign substance by the filter part 411 gathers, and 218 is a third anion contact reaction chamber in which the air having the second anion contact reaction has an anion contact reaction finally by the anion generated by the third anion generation part 214.

The operation of the air purification using the non-discharge type air purification apparatus for industry will be described based on the construction of the non-discharge air purification apparatus for industry of the first embodiment of the present invention.

The bad smell and polluted air inputted via the inlet part 201 of the main body part 210 is inputted into the interior of the enlarged conical pipe, and the flowing rate decreases from about 15˜18 m/sec to 0.3˜1 m/sec and flows via the filter part 211 through the first chamber 202. At this time, the filter part 211 filters the dusts and foreign substance (in particular adhesive dusts) of above 0.5 um contained in the exhaust gas. The exhaust gas containing bad smell, from which the dusts of above 0.5 um are removed, flows via the first anion generation part 212 and the first anion contact reaction chamber 216. At this time, the anion (positive or negative ions) generated by the first anion generation part 212 contacts with the bad smell exhaust gas and is mixed for thereby destroying the molecular coupling of the bad smell materials. In addition, in case of a hydro carbon in which it is coupled with oxygen in the exhaust gas with the help of the oxygen cluster, the reaction is performed based on carbonic acid and vapor. At this time, the anion works as a cluster which destroys the molecular coupling. The exhaust gas, which had the first anion contact reaction via the first anion contact reaction chamber 216, flows the second anion generation part 213 and the second anion contact reaction chamber 217. The other anion and cation generated in the second anion generation part 213 generated in the second anion generation part 213 flow via the first anion contact reaction chamber 216 and contact with the exhaust gas from which bad small is partially removed, and are mixed with the same for thereby further destroying the molecular coupling or ion coupling of the bad smell material and react with the oxygen in the exhaust gas and hydrocarbon and vapor.

As described above, the exhaust gas, which completed the first and second anion contact reaction, is processed via the third anion generation part 214 and the third anion contact reaction chamber 218 and contacts with other anions and cation of the third anion generation part 214 and flows via the first and second anion contact reaction chambers 216 and 217 and contacts and reacts with the bad smell for thereby further destroying the molecular coupling or ion coupling of the bad smell, so that it reacts with the oxygen of the exhaust gas and hydrocarbon and vapor. In addition, the exhaust gas processed via the third anion contact reaction chamber 218 is discharged to the outside via the air discharge part 240.

In the present invention, a series air purification process is finished in the non-discharge type air purification apparatus. When adapting to the industry field, it may be solely adapted or it may be adapted in combination with a conventional air purification method or a bad smell decrease method or apparatus, for example, a washing method, oxygen oxidation method, chemical absorption method, absorption method, combustion method, catalyst method, biological smell removal method, bad smell removable agent spraying method, etc.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A non-discharge type air purification apparatus for industry, comprising:
a main body part which has a rectangular cubic body except for an inlet and outlet part of air, with the body being horizontally installed with respect to the ground, for thereby purifying based on a filtering and multiple step anion contact reactions by receiving a bad smell and polluted air into the body;
a heating part which is connected with the main body part and the pipeline and heats a fluid for supplying a heating fluid as a supply medium of the heat for generating anion in the interior of the main body part;
a circulation pump which is installed at a pipeline between the main body part and the heating part and circulates the fluid heated by the heating part in the interior of the main body part;
an air discharge part which is mechanically connected with the gas outlet side of the main body part and forcibly discharges the air purified in the main body part to the outside of the main body part; and
a control part which is installed near the main body part and is electrically connected with the circulation pump and air discharge part for thereby controlling the operations of the same.

2. The apparatus of claim 1, wherein said main body part 210 comprises a filter part 211 which first filters a bad smell and pollutant inputted into the body via the inlet part 201 and is formed of a double filtering structure for filtering a relatively larger particle (for example, above 0.5 um) and foreign substance (particular, adhesive dusts), a first anion generation part 212 which is distanced from the filter part 211 and first generates anions based on a first anion contact reaction of the air from which the dust and foreign substances are removed via the filter part 211, a second anion generation part 213 which is installed at a distance from the first anion generation part 212 and generates anion for a second anion contact reaction of the air which had the first anion contact reaction via the first anion generation unit 212, and a third anion generation unit 214 which is distanced from the second anion generation unit 213 and generates anion for a third anion contact reaction of the air which had the second anion contact reaction via the second anion generation part 213, with the above elements being sequentially installed.

3. The apparatus of claim 2, wherein a temperature sensor 210s is installed at the first and second anion contact reaction chambers 216 and 217 for detecting a temperature of the interior of the reaction chamber.

4. The apparatus of claim 1, wherein a temperature sensor 220s is installed at the heating tank of the heating part for detecting a temperature of the heating fluid.

5. The apparatus of claim 1, wherein a gas concentration sensor 240s is installed at an air discharge pipe of an air discharge part for detecting a concentration of air (gas).

6. The apparatus of claim 1, wherein said control part 250 transmits a control signal for adjusting a heating level to the heating source of the heating part 220 in accordance with a detection signal (concentration of exhaust gas) from the gas concentration sensor 240s for thereby decreasing or increasing the generation amount of heat, so that it is possible to adjust the amount of the heat energy supplied to the anion generation parts 213, 214 and 215.

7. A non-discharge type air purification apparatus for industry, comprising:
a main body part which has a cylindrical body, with the body being vertically installed with respect to the ground, for receiving a bad smell and polluted air into the interior of the body and purifying the same based on a filtering and multiple steps anion contact reactions;
an air transmission part which is mechanically connected with the gas entrance part of the main body part and forcibly flows the bad smell and polluted gas into the interior of the main body part;
a heating part which is installed at the anion generation part of the interior of the main body part and receives external electrical energy and generates heat for generating the anion of the interior of the main body; and
a control part which is installed near the main body part and is electrically connected with the air transmission part and the heating part and controls the operations of the same.

8. The apparatus of claim 7, wherein said main body part 310 comprises a filter part 311 which first filters bad smell and polluted gas inputted into the body like the first embodiment and is formed of a double filter structure for filtering relatively large size particles, a first anion generation part 312 which is distanced from the filter part 311 and generates an anion for a first anion contact reaction of the air from which the dust and foreign substances are moved by the filter part 311, a second anion generation part 313 which is distanced from the first anion generation part 312 and generates an anion for a second anion contact reaction of the air which completed the first anion contact reaction, a third anion generation part 314 which is distanced from the second anion generation part 313 and generates an anion for a third anion contact reaction of the air which had a second anion contact reaction via the second anion generation part 313, with the above elements being sequentially installed.

9. The apparatus of claim 8, wherein manholes 315h through 319h are formed at the first chamber 315 of the front side of the filter part 311, and the second chamber 316 of the rear side of the filter part 311, and the first anion contact reaction chamber 317, and the second anion contact reaction chamber 318 and the third anion contact reaction chamber 319 for checking and cleaning the interior of each chamber.

10. A non-discharge type air purification apparatus for industry, comprising:
a main body part which has two rectangular cubic bodies, with the bodies being horizontally stacked with respect to the ground, for receiving a bad smell and polluted air into the interior of the body and purifying the same based on a filtering and multiple steps anion contact reactions;
an air transmission part which is mechanically connected with the gas entrance part of the main body part and forcibly flows the bad smell and polluted gas into the interior of the main body part;
a heating part which is installed at the anion generation part of the interior of the main body part and receives external electrical energy and generates heat for generating the anion of the interior of the main body; and
a control part which is installed near the main body part and is electrically connected with the air transmission part and the heating part and controls the operations of the same.

11. The apparatus of claim 10, wherein said main body part 410 comprises a double filter part 411 which filters the bad smell and polluted air inputted via the gas entrance part 401 and filters relatively large size particles, a first anion generation part 412 which is distanced from the filter part 411 and generates an anion for the first anion contact reaction of the air having no dusts and foreign substances via the filter 411, a second anion generation part 413 which is distanced from the first anion generation part 412 for generating an anion for the second anion contact reaction of the air which had the first anion contact reaction via the first anion generation part 412, a third anion generation part 414 which is distanced from the second anion generation part 413 and generates an anion for the third anion contact reaction of the air which had the second anion contact reaction via the second anion generation part 413, a fourth anion generation part 415 which is distanced from the third anion generation part 414 and generates an anion for the fourth anion contact reaction of the air which had the third anion contact reaction via the third anion generation part 414, and a fifth anion generation part 416 which generates an anion for the fifth anion contact reaction of the air which had the fourth anion contact reaction via the fourth anion generation part 415, with the above elements being sequentially installed.
